(19) United States
(12) Patent Application Publication
(10) Pub. No.: US 2005/0002843 A1
(43) Pub. Date: Jan. 6, 2005

(54) Catalytic process for nitrogen oxides reduction by multi-injection and use thereof

(75) Inventors: Du-Soung Kim, Seoul (KR); Jihn-Koo Lee, Seosan-si (KR); Myoung-Jin Kha, Seosan-si (KR); Seung-Jae Lee, Seosan-si (KR)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Kocat Inc., Seoul (KR)

(21) Appl. No.: 10/839,973

(22) Filed: May 6, 2004

(30) Foreign Application Priority Data
May 7, 2003 (KR) 10-2003-0028926
Mar. 27, 2004 (KR) 10-2004-0020956

(51) Int. Cl. B01D 53/56

(52) U.S. Cl. 423/239.1; 502/348; 422/180; 422/172; 422/177

(57) ABSTRACT

Disclosed is a method of effectively removing nitrogen oxides contained in an exhaust gas from a combustion process with a stationary source and/or a mobile source using gases or liquid oils as a fuel, such as gasoline, kerosene and bio-diesel oil. More particularly, provided are an apparatus and a method of removing nitrogen oxides, in which a reducing agent is sprayed into the exhaust gas passing through an alumina-promoted silver catalyst installed at the flow path of the exhaust gas.

### RELATED APPLICATION

This application claims priority under 35 U.S.C. § 119 or 365 to Republic of Korea Patent Application Nos. 10-2003-0028926, filed May 7, 2003, and 10-2004-0020956, filed Mar. 27, 2004. The entire teachings of these Korean Patent Applications are incorporated herein by reference.

### TECHNICAL FIELD

Generally, the present invention relates to a method of treating nitrogen oxides (NOx) contained in an exhaust gas from a combustion process of a stationary source and a mobile source using gases and liquid oils as fuels, such as gasoline, kerosene and bio-diesel oil. Particularly, the present invention relates to an apparatus and a method of treating nitrogen oxides where an alumina-promoted silver catalyst is installed in a flow path of the exhaust gas and a reducing agent is sprayed into the exhaust gas passing through the catalyst.

### BACKGROUND OF THE INVENTION

As well known to those skilled in the art, a composition of nitrogen compounds contained in a combustion exhaust gas varies, sensitively depending on the type of fuel and operational conditions of an engine. A selective catalytic reduction (SCR) process is a conventional process used for removing nitrogen oxides, in which nitrogen oxides are broken down into nitrogen and water by a reaction with a reducing agent in the presence of a catalyst. Ammonia is widely used as the reducing agent in the selective catalytic reduction process, because it has excellent catalytic reactivity and selectivity.

For example, U.S. Pat. No. 5,024,981 discloses an NH₃-SCR process for selectively removing nitrogen oxides contained in the exhaust gas with a honeycomb-structured catalyst, in which an active material, comprising vanadium or tungsten, is supported by a titania carrier.

However, ammonia is a very toxic gas, and the allowable limit of ammonia is significantly lower (5 ppm or lower) than that of nitrogen oxides. Thus, leakage of ammonia can cause serious environmental pollution. For this reason, practically, after the amount of nitrogen oxides contained in the exhaust gas is measured by an analyzer, a corresponding ammonia amount is sprayed into the exhaust gas to reduce nitrogen oxides. However, it is difficult to effectively reduce nitrogen oxides if the concentration of nitrogen oxides varies. Also, in the case of spraying ammonia into the exhaust gas after the amount of nitrogen oxides is analyzed, an undesirable time lag occurs, causing an ammonia-slip phenomenon in which nitrogen oxides and unused ammonia pass through a catalytic bed without reacting with each other. The molar ratio of ammonia to nitrogen oxides may be controlled to be 1 or lower to minimize the ammonia-slip phenomenon. However, control of the molar ratio of ammonia to nitrogen oxides still cannot overcome the above mentioned disadvantages.

In accordance with a recent trend of large-sized buildings and amusement facilities, an independent electric power plant for a stable electricity supply is installed in the buildings and amusement facilities. Ammonia may be used as the reducing agent to reduce nitrogen oxides discharged from the independent electric power plant. However, use of ammonia is strictly limited because of potential large-scaled accidents due to the leakage of ammonia, which can lead to serious environmental pollution.

To overcome the disadvantages of the NH₃-SCR process, an HC-SCR (hydrocarbon SCR) process recently has been started to be used, in which hydrocarbons is used as a reducing agent. For example, an HC-SCR process using propane as the reducing agent is discussed in U.S. Pat. No. 5,993,764. However, the process has not been commercialized yet because of its low removal activity of nitrogen oxides. U.S. Pat. Nos. 5,824,621 and 6,284,211 B1 discuss an ethanol-SCR process for converting nitrogen oxides into nitrogen using ethanol as a reducing agent in the presence of a silver catalyst, which is being commercialized. Generally ethanol has a relatively high removal effect of nitrogen oxides in comparison with other hydrocarbon-based reducing agents.

### SUMMARY OF THE INVENTION

The present invention has been made, keeping in mind the above problems in the prior art. An object of the present invention is to provide a catalyst for reducing nitrogen oxides contained in an exhaust gas from a combustion process of a stationary source and/or a mobile source.

Another object of the present invention is to provide an apparatus for removing nitrogen oxides contained in an exhaust gas from a combustion process of a stationary source and mobile source, in which a reducing agent is injected into the exhaust gas passing through an alumina-promoted silver catalyst installed in the flow path of the exhaust gas.

It is still another object of the present invention to provide a method of removing nitrogen oxides contained in an exhaust gas from a combustion process of a stationary and/or a a mobile source.

In order to accomplish the above objects, the present invention provides an alumina-promoted silver catalyst for removing nitrogen oxides.

Further, the present invention provides an apparatus for treating nitrogen oxides that includes an inlet pipe to receive the exhaust gas. A reactor includes one or more nozzles connected to the inlet pipe to spray air and a reducing agent to the exhaust gas passing into the reactor through the inlet pipe. The reactor also includes at least one catalytic bed installed behind the nozzle to reduce nitrogen oxides from the exhaust gas laden with the reducing agent. A storage tank stores therein the reducing agent to be sprayed by the nozzle. An injection pump is installed between the storage tank and the nozzle to transport the reducing agent from the storage tank to the nozzle. Additionally, an air pump is connected to the nozzle to feed air into the nozzle. An outlet pipe discharges the exhaust gas that has gone through the catalytic bed.

Furthermore, the present invention provides a method of treating exhaust gas, including the steps of injecting a reducing agent into the exhaust gas containing nitrogen oxides from a combustion process of a stationary source or a mobile source and of passing the treated exhaust gas with the reducing agent through a catalytic bed to reduce nitrogen oxides contained in the exhaust gas.

Nitrogen oxides (NOx) in the present invention means compounds such as NO, NO₂, N₂O₅ and N₂O. The term “nitrogen oxides” is used to describe one or more of NO, NO₂, N₂O₅, N₂O and other oxides of nitrogen. It is understood that the word “reducing” as used herein is to reduce nitrogen oxides contained in the exhaust gas, and generally has the same meaning as removing nitrogen oxides.

### BRIEF DESCRIPTION OF THE DRAWINGS

The objects, features and advantages of the present invention will be more clearly understood from the following detailed description taken in conjunction with the accompanying drawings, in which:

FIG. 1 illustrates an apparatus for treating nitrogen oxides according to an embodiment of the present invention;

FIG. 2 illustrates another aspect of the apparatus for treating nitrogen oxides according to an embodiment of the present invention;

FIG. 3 is a graph showing the conversion efficiency of nitrogen oxides as a function of the temperature of an exhaust gas that excludes sulfur dioxide;

FIG. 4 is a graph showing the conversion efficiency of nitrogen oxides as a function of the temperature of an exhaust gas that includes sulfur dioxide;

FIG. 5 is a graph showing the conversion efficiency of nitrogen oxides in the case of using a sulfuric acid-treated catalyst;

FIG. 6 is a graph showing the conversion efficiency of nitrogen oxides with the use of a sulfuric acid-treated catalyst and without the use of a sulfuric acid-treated catalyst;

FIG. 7 is a graph showing the conversion efficiency of nitrogen oxides as a function of a molar ratio of ethanol to nitrogen oxides in the case of spraying ethanol into the exhaust gas according to a single injection manner;

FIG. 8 is a graph showing the conversion efficiency of nitrogen oxides as a function of a molar ratio of ethanol to nitrogen oxides in the case of spraying ethanol into the exhaust gas according to a double-injection manner;

FIG. 9 is a graph showing the conversion efficiency of nitrogen oxides in accordance with a fuel type used in a stationary source in the case of spraying ethanol to the exhaust gas according to a double-injection manner; and

FIG. 10 is a graph showing the generation efficiency of N₂O in accordance with a fuel type used in a stationary source in the case of spraying ethanol to the exhaust gas according to a double-injection manner.

### DETAILED DESCRIPTION OF THE INVENTION

According to the present invention, a catalyst for reducing nitrogen oxides comprises silver and alumina(Ag/Al₂O₃). The catalyst can be further treated by sulfuric acid. The catalyst further treated by sulfuric acid includes sulfates, and exists in the form of Ag/Al₂O₃—SO₄²⁻.

It is preferable that an alumina carrier has an amorphous, gamma-type, theta-type, or eta-type crystalline structure in order to reduce nitrogen oxides easily. For use in a catalyst, the alumina carrier that has various crystalline structures, as described above, is coated on a honeycomb body, and preferably on a cordierite honeycomb body. Additionally, the content of the alumina carrier in the catalyst is preferably 0.05 to 0.3 g/cm³ based on the whole catalyst. If the content of the alumina carrier is less than 0.05 g/cm³, catalytic activity is greatly reduced. The catalytic activity increases as the content increases up to 0.3 g/cm³. When the content is more than 0.3 g/cm³, the catalytic activity no longer increases.

A “catalytic bed” designates a honeycomb body coated with the catalyst, and installed in the apparatus for treating nitrogen oxides.

In the present invention, silver is provided in a form of reduced silver (Ag°), silver oxide (AgO), silver chloride (AgCl), silver nitrate (AgNO₃), silver sulfate (Ag₂SO₄), or a mixture thereof. The amount of silver is preferably 1 to 10 wt % based on the alumina carrier. If the amount of silver is less than 1 wt %, catalytic activity is greatly reduced. On the other hand, if the amount of silver is greater than 10 wt %, the catalytic activity no longer increases.

According to the present invention, the catalyst for removing nitrogen oxides optionally can be placed in a 0.01 to 1 M sulfuric acid aqueous solution to treat the catalyst with sulfuric acid. In this case, the catalyst exists in the form of Ag/Al₂O₃—SO₄²⁻.

When the alumina-promoted silver catalyst is used to reduce nitrogen oxides after being placed in a 0.01 to 1M sulfuric acid aqueous solution, removal activity of nitrogen oxides of the resulting catalyst is greatly improved at a predetermined temperature range. For example, at a temperature of 250 to 500° C., poisoning resistance of the catalyst to sulfur dioxide is improved.

Alternatively, instead of placing the catalyst in a sulfuric acid aqueous solution, sulfur dioxide may be continuously injected into the alumina-promoted silver catalyst to treat the catalyst with sulfuric acid. The sulfuric acid-treated catalyst using sulfur dioxide has similar catalytic activity to that of the sulfuric acid-treated catalyst using a sulfuric acid aqueous solution.

In the present invention, the term “sulfuric acid-treated” means that the catalyst is placed in a sulfuric acid aqueous solution, or continuously injected by sulfur dioxide.

Also, it should be understood that the word “catalyst” as used herein is intended to include not only the alumina-promoted silver catalyst, but also the honeycomb body on which silver is coated.

Hereinafter, a description of a method of producing the catalyst for reducing nitrogen oxides according to the present invention will be given. In a preferred embodiment, the catalyst of the present invention is coated on the honeycomb body, and the method of producing the catalyst coated on the honeycomb body is described herein.

The method of producing the catalyst according to the present invention includes the steps of slowly adding alumina to ion-exchanged water with strong agitation to produce a homogeneous slurry; coating such slurry on the honeycomb body, preferably on the cordierite honeycomb body, more preferably on the cordierite honeycomb body with a size of about 15×15×10 cm and a cell density of about 200 cells/in² (84×84 cells); firstly drying the coated honeycomb body at room temperature for about 24 hours; drying the firstly dried honeycomb body at about 120° C. for about 4 hours, heating the dried honeycomb body at a rate of about 10° C./min to 500 to 700° C. and calcining the heated honeycomb body at 500 to 700° C. for about 2 hours; drying the calcined honeycomb body at room temperature for about 24 hours after placing the calcined honeycomb body in a silver-containing solution, such as silver chloride (AgCl), silver nitrate (AgNO₃), silver sulfate (Ag₂SO₄), or a mixture thereof; drying at about 120° C. for about 4 hours the honeycomb body placed in the silver-containing solution and then heating the honeycomb body at a rate of about 10° C./min to 500 to 700° C.; and calcining again the honeycomb body at 500 to 700° C. for about 2 hours.

In the present invention, the catalyst for removing nitrogen oxides optionally is placed in an acid solution, such as a 0.01 to 1 M sulfuric acid aqueous solution, and then dried at room temperature for about 24 hours. The next step is to further dry the catalyst at about 120° C. for about 4 hours, then heat at a rate of about 10° C./min to 500 to 700° C., and finally, calcine at 500 to 700° C. for about 2 hours, thereby accomplishing the sulfuric acid-treated catalyst according to the present invention.

In the apparatus for treating nitrogen oxides according to the present invention, the exhaust gas, discharged from a combustion process of a stationary source and/or a mobile source, preferably a combustion process of a stationary source and/or a mobile source using gases or gasoline as a fuel, contains a lower content of sulfur oxides, such as sulfur dioxide, than does the exhaust gas from a combustion process of a stationary source and/or a mobile source using coals as a fuel.

A reducing agent according to the present invention is sprayed into the exhaust gas with air through the nozzle to reduce nitrogen oxides contained in the exhaust gas into nitrogen and water. The molar ratio of the reducing agent to nitrogen oxides contained in the exhaust gas is at least 0.1 or above.

The reducing agent for reducing nitrogen oxides to nitrogen may be any substance, including hydrocarbons, such as unsaturated hydrocarbon, heterogeneous hydrocarbon and preferably, ethanol.

Air allows the reducing agent to be widely sprayed from the nozzles into the exhaust gas. Any gas can be used instead of air as long as it is inert and does not react with the reducing agent. However, it is preferable that air is used in conjunction with the reducing agent in consideration of its price and ease in obtaining it.

Reference should now be made to the drawings, in which the same numbers are referred to throughout the different drawings to designate the same or similar components.

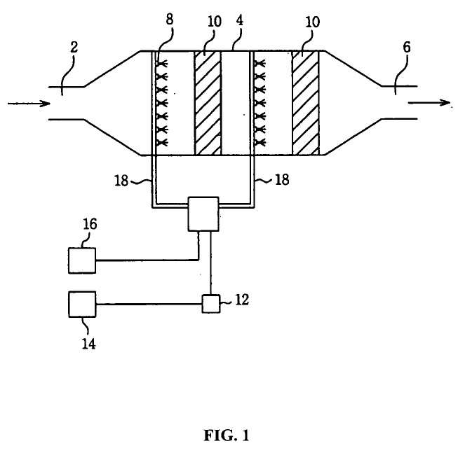

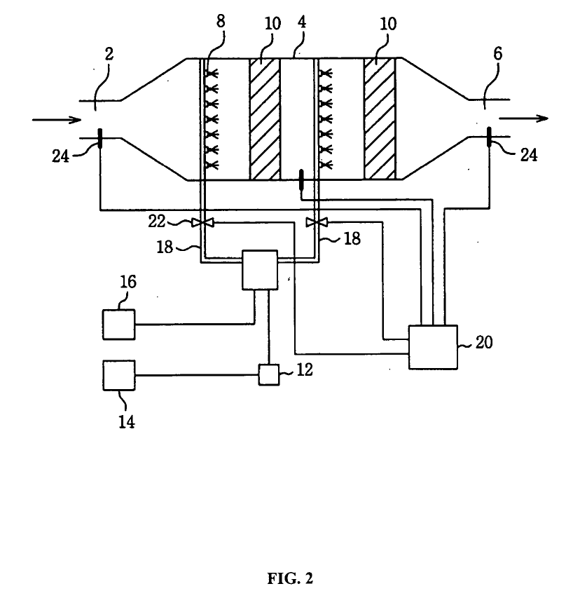

FIG. 1 illustrates an apparatus for treating nitrogen oxides according to an embodiment of the present invention. FIG. 2 illustrates another aspect of an apparatus for treating nitrogen oxides according to an embodiment of the present invention.

With reference to FIGS. 1 and 2, the apparatus for treating nitrogen oxides according to the present invention includes an inlet pipe 2 to receive an exhaust gas containing nitrogen oxides from a stationary source and mobile source, acting as a flow path for the exhaust gas. Preferably, the combustion process of the stationary source and mobile source uses gases or liquid oils as a fuel, such as gasoline, kerosene and bio-diesel oil. A reactor 4 includes one or more nozzles 8 that are connected to the inlet pipe 2 to spray air and a reducing agent to the exhaust gas passing the reactor 4 through the inlet pipe 2; and one or more catalytic beds 10 installed behind the nozzles 8 to reduce nitrogen oxides from the exhaust gas laden with the reducing agent. A storage tank 14 stores therein the reducing agent to be sprayed by the nozzles 8. An injection pump 12 is installed between the storage tank 14 and the nozzles 8 to transport the reducing agent from the storage tank 14 to the nozzles 8. Additionally, an air pump 16 is connected to the nozzles 8 to feed air into the nozzles 8. An outlet pipe 6 discharges the exhaust gas after the exhaust gas passes through and is treated by the catalytic beds 10.

The reactor 4 is defined as a space in which the nozzles 8 and catalytic beds 10 are installed to reduce nitrogen oxides contained in the exhaust gas.

The nozzles 8 and catalytic beds 10 are installed in the reactor 4 in such a way that a tube, including the nozzles 8, is positioned at the front of each catalytic bed 10 based on a flow direction of the exhaust gas. In the case of installing one or more tubes and catalytic beds 10 in the reactor 4, the tube pairs with a catalytic bed 10, and the tube and catalytic bed 10 are alternately positioned in the reactor 4.

The inlet pipe 2, according to the present invention, is connected to the stationary or mobile source at the beginning part thereof to receive the exhaust gas containing nitrogen oxides from the combustion process of the stationary or mobile source, and sequentially is connected to the reactor 4 and the outlet pipe 6 at the ending part thereof to reduce nitrogen oxides contained in the exhaust gas and discharge the treated exhaust gas through the outlet pipe.

The nozzles 8 according to the present invention are installed in the reactor 4 to spray air and the reducing agent to the exhaust gas containing nitrogen oxides that passes through the reactor 4. The nozzles 8 may be installed in any manner in the reactor 4 so long as air and the reducing agent are desirably sprayed into the exhaust gas. Preferably, the nozzles 8 can be installed in the reactor 4 in a single- or multi-injection manner to easily spray air and the reducing agent into the exhaust gas containing nitrogen oxides at 200 to 500° C. through the reactor 4.

It is called a single-injection manner when a single tube 18 is structured such that a plurality of holes is formed on a surface of the tube 18 and the nozzles 8 are connected to the holes. In a multi-injection manner, two or more tubes are installed in the reactor 4, as described above.

According to the multi-stage injection manner, when a hydrocarbon-based reducing agent, such as ethanol, is injected into the reactor 4, it is judged against the amount of the sprayed reducing agent whether the amount of the reducing agent consumed during the reduction of nitrogen oxides is proper or not. Thus, the multi-stage injection manner has higher removal activity of nitrogen oxides than that of the single-stage injection manner at the same amount of the reducing agent as used in the multi-stage injection manner.

The apparatus for treating nitrogen oxides according to the present invention may optionally further comprise valves 22 installed in the tubes 18 to control the flow rate of a fluid passing through each of the tubes 18. One or more concentration sensors 24 are installed in the inlet pipe 2, the reactor 4, or the outlet pipe 6 to sense the concentration of nitrogen oxides that exist in the exhaust gas flowing through the inlet pipe 2, the reactor 4 and the outlet pipe 6. A control unit 20 connected to the valves 22 and concentration sensors 24 to control the valves 22 based on concentration data from the concentration sensors 24 may also be installed.

In the present invention, the concentration sensors 24 can be installed at any position in the inlet pipe 2, the reactor 4 and the outlet pipe 6 so long as the concentration of the exhaust gas flowing in the inlet pipe 2, the reactor 4, and the outlet pipe 6 are easily measured.

The nozzles 8 and an outer surface of each of the tubes 18 connected to the nozzles 8 may optionally be insulated by an insulating material to prevent the exhaust gas at 200 to 500° C. from combusting the reducing agent. Additionally, cool air may be fed through the nozzles 8 and/or tubes 18 that are covered by an insulating material to effectively prevent the reducing agent passing through the nozzles 8 and the tubes 18 from being combusted by the high temperature of the exhaust gas.

As described above, the nozzles 8 that function to spray air and the reducing agent are connected to the air pump 16 that compresses air supplied from the atmosphere. The nozzles 8 are also sequentially connected to the injection pump 12 that feeds the reducing agent to the nozzles 8, and the storage tank 14 that stores the reducing agent therein. The injection pump 12 acts as a power source to feed the reducing agent from the storage tank 14 to the nozzles 8.

In the present invention, the air pump 16 supplies the compressed air with the reducing agent into the nozzles 8. The air pump 16 allows injecting the reducing agent at a high pressure into the reactor 4, thereby the exhaust gas containing nitrogen oxides and the reducing agent are readily mixed.

Hereinafter, a preferred operation mode of the apparatus according to the present invention will be described.

The exhaust gas containing nitrogen oxides from the combustion process of the stationary source and mobile source using gas or liquid oil, such as gasoline, kerosene or bio-diesel oil as fuel is fed through the inlet pipe 2 into the reactor 4 which includes the nozzles 8 and catalytic beds 10.

The reducing agent stored in the storage tank 14 is then fed into the nozzles 8 by the injection pump 12, and air is simultaneously fed into the nozzles 8 by air the pump 16.

Additionally, air and the reducing agent fed into the nozzles 8 positioned in the reactor 4 are sprayed into the exhaust gas containing nitrogen oxides passing through the reactor 4.

Further, the exhaust gas mixed with the reducing agent passes through the catalytic beds 10 positioned behind the nozzles 8 to reduce nitrogen oxides contained in the exhaust gas to nitrogen.

Furthermore, the treated exhaust gas is discharged through the outlet pipe 6 connected to the ending part of the reactor 4.

Compressed air from the air pump 16 is fed in conjunction with the reducing agent into the nozzles 8, which allows spraying the reducing agent at a high pressure into the exhaust gas so that the exhaust gas containing nitrogen oxides and the reducing agent are readily mixed.

The apparatus for treating the exhaust gas according to the present invention may include the concentration sensors 24 for sensing a concentration of nitrogen oxides contained in the exhaust gas, and can effectively treat the exhaust gas using the control unit 20 that controls the valves 22 based on the concentration data measured by the concentration sensors 24.

As described above, the apparatus is structured such that one or more tubes 18, each including a plurality of nozzles 8, are installed in the reactor 4, each of the tube 18 is connected to the injection pump 12 and air pump 16 and at least one concentration sensor 24 is installed in the inlet pipe 2, the reactor 4 and the outlet pipe 6.

The valves 22 that control the degree of opening and closing of the tubes are installed in the tubes 18. The valves 22 and concentration sensors 24 are connected to the control unit 20.

When the exhaust gas containing nitrogen oxides is discharged from the combustion process of the stationary source and mobile source using gases or liquid oil as a fuel, such as gasoline, kerosene or bio-diesel oil, the exhaust gas is fed into the reactor 4 past the tubes 18, each including a plurality of nozzles 8.

In the present invention, the concentration of nitrogen oxides contained in the exhaust gas is measured by the concentration sensors 24 installed in the inlet pipe 2, the reactor 4 and the outlet pipe 6, which can transmit the concentration data to the control unit 20.

After a removal activity rate of nitrogen oxides by the catalytic beds 10 is estimated based on the concentration data output from the concentration sensors 24, the control unit 20 opens the valve 22 of a tube 18 positioned at the front of the catalytic bed 10 poisoned by the reaction of the exhaust gas and the reducing agent, while closeing the valve 22 of another tube 18 positioned at the front of the non-poisoned catalytic bed 10.

The reducing agent stored in the storage tank 14 is then fed into the tube 18, of which the valve 22 is opened, using the injection pump 12, and atmospheric air is fed in conjunction with the reducing agent into the tube 18, of which the valve 22 is opened, using the air pump 16.

Additionally, air and the reducing agent fed into the tube 18, of which the valve 22 is opened, are sprayed into the exhaust gas containing nitrogen oxides flowing in the reactor 4 through the nozzles 8 of the tube 18.

Further, the exhaust gas mixed with the reducing agent passes through the catalytic beds 10 positioned behind the nozzles 8 to reduce nitrogen oxides contained in the exhaust gas into nitrogen.

Subsequently, the treated exhaust gas is discharged through the outlet pipe 6 connected to the ending part of the reactor 4. Compressed air from the air pump 16 is fed in conjunction with the reducing agent into the nozzles 8, which allows that the exhaust gas is readily mixed with the reducing agent.

A better understanding of the present invention may be obtained through the following examples which are set forth to illustrate, but not to be construed as to limit of the present invention.

### EXAMPLE 1

Production of Non-Sulfuric Acid-Treated Catalytic Bed 1

Alumina [Spheralite 557, Exxons, France] was slowly added to ion-exchanged water with strong agitation to produce a homogeneous slurry.

The slurry was coated on a cordierite honeycomb body [Facktop Kocat, China] with a size of 15×15×10 cm and cell density of 200 cells/in² (84×84 cells) so that a ratio of alumina to the cordierite honeycomb body was 0.111 g/cm³, and then dried at room temperature for 24 hours.

The dried honeycomb body was again dried at 120° C. for 4 hours and then heated at a rate of 10° C./min to 600° C., and calcined at 600° C. for 2 hours.

The calcined honeycomb body on which alumina was coated was placed in a silver nitrate aqueous solution (AgNO₃)[Hangyeol Gold, Korea] so that the silver content in the resulting honeycomb body was 2.1 wt % based on alumina, and then dried at room temperature for 24 hours.

The resulting honeycomb body was then dried at 120° C. for 4 hours, heated at a rate of 10° C./min to 600° C. and then calcined at 600° C. for 2 hours.

### EXAMPLE 2

Production of Non-Sulfuric Acid-Treated Catalytic Bed 2

The procedure of example 1 was repeated with the exception that the ratio of alumina to the cordierite honeycomb body, was 0.123 g/cm³ instead of 0.111 g/cm³, and the silver content in the resulting honeycomb body was 5.0 wt % instead of 2.1 wt % based on alumina.

### EXAMPLE 3

Production of Non-Sulfuric Acid-Treated Catalytic Bed 3

The procedure of example 1 was repeated except that the ratio of alumina to the cordierite honeycomb body was 0.149 g/cm³ instead of 0.111 g/cm³, and the silver content in the resulting honeycomb body was 6.0 wt % instead of 2.1 wt % based on alumina.

### EXAMPLE 4

Production of Sulfuric Acid-Treated Catalytic Bed 1

The catalytic bed produced according to example 2 was placed in 0.1 M sulfuric acid aqueous solution [sulfuric acid, Duk-san Pharmaceutical Industry Co. Ltd., Korea], and dried at room temperature for 24 hours.

The dried catalytic bed was again dried at 120° C. for 4 hours, heated at a rate of 10° C./min to 500° C., and calcined at 500° C. for 2 hours to produce the sulfuric acid-treated catalytic bed.

The produced sulfuric acid-treated catalytic bed had a ratio of alumina to the honeycomb body of 0.123 g/cm³, a silver content in the resulting catalytic bed of 5.0 wt % based on alumina, and a sulfate (SO₄²⁻) content in the resulting catalytic bed of 1 wt % based on alumina.

### EXAMPLE 5

Production of Sulfuric Acid-Treated Catalytic bed 2

The procedure of example 4 was repeated except that 0.21 M sulfuric acid aqueous solution was used instead of 0.1 M sulfuric acid aqueous solution.

The produced sulfuric acid-treated catalytic bed had a ratio of alumina to the honeycomb body of 0.123 g/cm³, a silver content in the resulting catalytic bed of 5.0 wt % based on alumina, and a sulfate (SO₄²⁻) content in the resulting catalytic bed of 2 wt % based on alumina.

### EXAMPLE 6

Production of Sulfuric Acid-treated Catalytic Bed 3

The procedure of example 4 was repeated except that 0.42 M sulfuric acid aqueous solution was used instead of 0.1 M sulfuric acid aqueous solution.

The resulting sulfuric acid-treated catalytic bed had a ratio of alumina to the honeycomb body of 0.123 g/cm³, a silver content in the resulting catalytic bed of 5.0 wt % based on alumina, and a sulfate (SO₄²⁻) content in the resulting catalytic bed of 4 wt % based on alumina.

### EXAMPLE 7

As shown in FIG. 1, a rectangular reactor [Gibo Co., Korea] made of SUS 304 with a height of 15 cm, a width of 15 cm and a length of 100 cm was provided, and a tube with a plurality of nozzles [TN050-SRW, Total nozzle Co., Korea] was installed in the reactor.

The catalytic bed according to example 1 was installed behind the tube having a plurality of nozzles in the reactor.

Ethanol [Duk-san Pharmaceutical Industry Co. Ltd., Korea] acting as a reducing agent was charged into a storage tank. The storage tank was connected to an injection pump [M930, Younglin Co., Korea] that was connected to the tube with the nozzles.

An air pump [HP 2.5, Air bank compressor Co., Korea] was then connected to the tube with the nozzles to feed compressed air into the reactor.

Exhaust gas discharged from a LPG (liquefied petroleum gas) burner [Eg02.9R, Elco, Germany] of a boiler [Jewoo royal steam boiler, Jewoo energy, Korea] and nitrogen monoxide [Metson, USA] were fed into the reactor, and the flow rate of the exhaust gas and nitrogen monoxide was controlled by using a mass flow controller [F-201C-FAC-22-V, Bronchost, Netherlands].

The flow rate and the composition of the exhaust gas are described in Table 1.

TABLE 1
Flow rate and composition of the exhaust gas

Composition

| Flow rate | NOx | CO | H₂O | O₂ |
|---|---|---|---|---|
| 90 Nm³h⁻¹ | 700 ppm | 1400 ppm | 6% | 11% |

When the exhaust gas that was fed into the reactor passed through the inlet pipe, high pressure air and ethanol were simultaneously fed into the nozzles using both the air pump and injection pump so as to be sprayed into the exhaust gas passing through the reactor.

The molar ratio of ethanol to nitrogen oxides fed into the reactor was controlled to be 1, and a K-type thermocouple was installed in the reactor to measure the temperature in the reactor.

Reaction conditions were controlled in such a way that the temperature in the reactor was 100 to 550° C. and the space velocity was 20,000 h⁻¹. The space velocity was calculated using the following equation 1.

$$space velocity ( SV , {h}^{- 1} ) = \frac{flow rate of exhaust gas ( {Nm}^{3} \text{/} hr )}{volume of catalyst ( {m}^{3} )} \qquad Equation 1$$

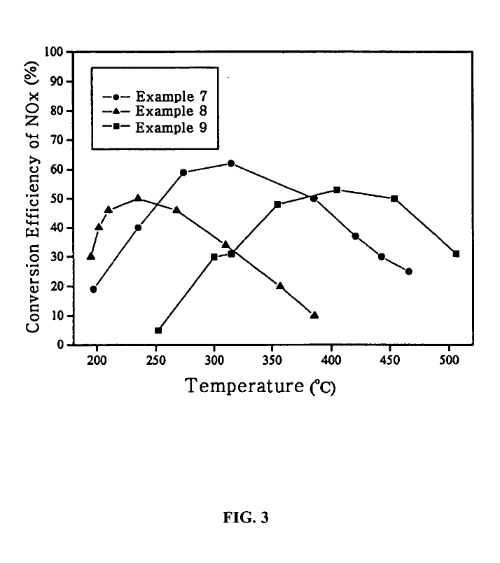

The concentration of the exhaust gas was analyzed by a portable nitrogen oxides analyzer[MK 2, Eurotron, Italy] before and after the reaction of nitrogen oxides with ethanol. Conversion efficiency of nitrogen oxide was calculated using the following Equation 2. The calculated results are shown in FIG. 3.

$$NO x convers . ( \% ) = [ \frac{\begin{matrix}NO x conc . before reaction - \\ NO x conc . after reaction\end{matrix}}{NO x conc . before reaction} ] \times 100 ( \% ) \qquad Equation 2$$

### EXAMPLE 8

The procedure of example 7 was repeated except that the catalytic bed according to example 2 was used instead of using the catalytic bed according to example 1.

The calculated conversion efficiency of nitrogen oxide for this system is shown in FIG. 3.

### EXAMPLE 9

The procedure of example 7 was repeated except that the catalytic bed according to example 5 was used instead of using the catalytic bed according to example 1.

The results are shown in FIG. 3.

As shown in FIG. 3, the temperature at which nitrogen oxides were maximally reduced varied with the alumina and silver amount contained in the catalytic beds when examples 7 and 8 were compared with each other. Additionally, in comparison of examples 7 and 9, the temperature at which nitrogen oxides were maximally reduced is shifted to a higher temperature when the sulfuric acid-treated catalytic beds were used (example 9).

### EXAMPLE 10

The procedure of example 7 was repeated except that a gasoline burner [OM-1, Olympia Co., Korea] was used instead of the LPG burner in example 7. The molar ratio of ethanol to nitrogen oxides was 2. The temperature in the reactor ranged from 200 to 550° C. The space velocity was 20,000 h⁻¹.

The flow rate and the composition of the exhaust gas are described in Table 2.

TABLE 2
Flow rate and composition of the exhaust gas

| | Composition | | | | |
|---|---|---|---|---|---|
| Flow rate | NOx | CO | H₂O | O₂ | SO₂ |
| 90 Nm³h⁻¹ | 700 ppm | 1400 ppm | 6% | 11% | 50 ppm |

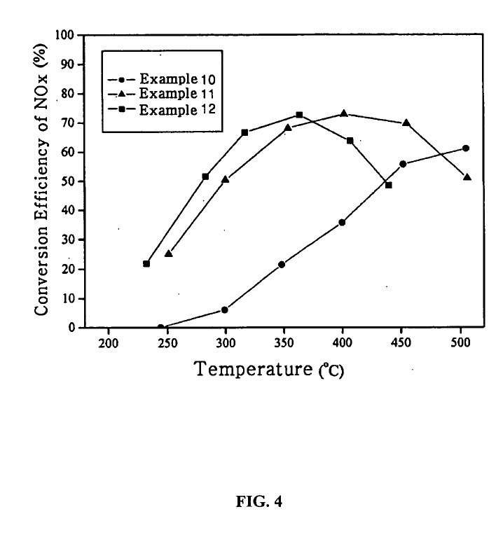

The calculated conversion efficiency of nitrogen oxide for this system is shown in FIG. 4.

### EXAMPLE 11

The procedure of example 7 was repeated except that the catalytic bed according to example 2 was used instead of the catalytic bed according to example 1. A gasoline burner was used instead of the LPG burner in example 7. The molar ratio of ethanol to nitrogen oxides was 2. The temperature in the reactor ranged from 200 to 550° C. The space velocity was 20,000 h⁻¹.

The composition of the exhaust gas fed into the reactor is described in Table 2. The calculated conversion efficiency of nitrogen oxide for this system is shown in FIG. 4.

### EXAMPLE 12

The procedure of example 7 was repeated that except the catalytic bed according to example 3 was used instead of the catalytic bed according to example 1. A gasoline burner was used instead of the LPG burner in example 7. The molar ratio of ethanol to nitrogen oxides was 2. The temperature in the reactor ranged from 200 to 550° C. The space velocity was 20,000 h⁻¹.

The composition of the exhaust gas fed into the reactor is described in Table 2. The calculated conversion efficiency of nitrogen oxide for this system is shown in FIG. 4.

### EXAMPLE 13

The procedure of example 7 was repeated except that an internal combustion power plant [5.6MW, 14PC 2.5V DF, Nikata, Japan] using 90% LNG+10% gasoline as a fuel was used instead of the LPG burner in example 7. The molar ratio of ethanol to nitrogen oxides was 2. The reactor temperature was 450° C. The flow rate of the exhaust gas was controlled in such a way that the space velocity was 20,000 h⁻¹ at a hybrid mode (90% LNG+10% gasoline) in which the composition and concentration of the exhaust gas were stable after the internal combustion power plant was operated.

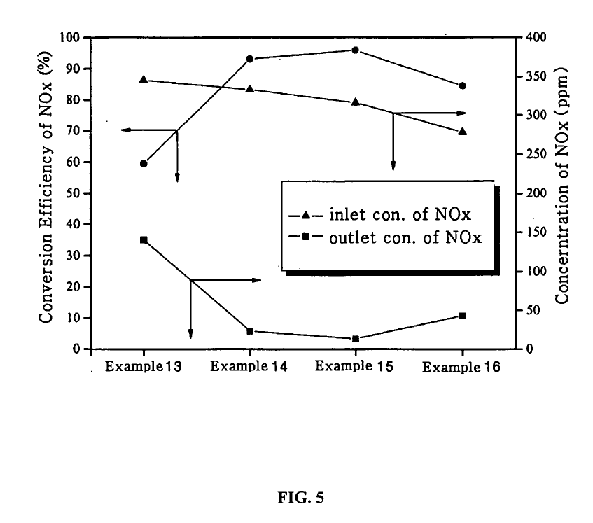

The flow rate and the composition of the exhaust gas fed into the reactor are described in Table 3. The calculated conversion efficiency of nitrogen oxide for this system is shown in FIG. 5.

TABLE 3
Flow rate and composition of the exhaust gas

| | Composition | | | | |
|---|---|---|---|---|---|
| Flow rate | NOx | CO | H₂O | O₂ | SO₂ |
| 90 Nm³h⁻¹ | 700 ppm | 1000 ppm | 6% | 10% | 15 ppm |

### EXAMPLE 14

The procedure of example 7 was repeated with the exception that the catalytic bed according to example 4 was used instead of the catalytic bed according to example 1. The internal combustion power plant using 90% LNG+10% gasoline as a fuel was used instead of the LPG burner in example 7. The molar ratio of ethanol to nitrogen oxides was 2. The reactor temperature was 450° C. The flow rate of the exhaust gas was controlled in such a way that the space velocity was 20,000 h⁻¹ at a hybrid mode (90% LNG+10% gasoline) in which the composition and concentration of the exhaust gas were stable after the internal combustion power plant was operated.

The composition of the exhaust gas fed into the reactor is described in Table 3. The calculated conversion efficiency of nitrogen oxide for this system is shown in FIG. 5.

### EXAMPLE 15

The procedure of example 7 was repeated except that the catalytic bed according to example 5 was used instead of the catalytic bed according to example 1. An internal combustion power plant using 90% LNG+10% gasoline as a fuel was used instead of the LPG burner in example 7. The molar ratio of ethanol to nitrogen oxides was 2. The reactor temperature was 450° C. The flow rate of the exhaust gas was controlled in such a way that the space velocity was 20,000 h⁻¹ at a hybrid mode (90% LNG+10% gasoline) in which the composition and concentration of the exhaust gas were stable after the internal combustion power plant was operated.

The composition of the exhaust gas fed into the reactor is described in Table 3. The calculated conversion efficiency of nitrogen oxide for this system is shown in FIG. 5.

### EXAMPLE 16

The procedure of example 7 was repeated except that the catalytic bed according to example 6 was used instead of the catalytic bed according to example 1. An internal combustion power plant using 90% LNG+10% gasoline as a fuel was used instead of the LPG burner in example 7. The molar ratio of ethanol to nitrogen oxides was 2. The reactor temperature was 450° C. The flow rate of the exhaust gas was controlled in such a way that the space velocity was 20,000 h⁻¹ at a hybrid mode (90% LNG+10% gasoline) in which the composition and concentration of the exhaust gas were stable after the internal combustion power plant was operated.

The composition of the exhaust gas fed into the reactor is described in Table 3. The calculated conversion efficiency of nitrogen oxide for this system is shown in FIG. 5.

As shown in FIG. 5, the conversion efficiency of nitrogen oxides contained in the exhaust gas from a stationary source and a mobile source using a mixed fuel (90% LNG+10% gasoline) varied with the quantity of sulfuric acid that was used for treating the catalytic beds. The catalytic beds according to examples 4 and 5 showed relatively high conversion efficiency of nitrogen oxides than the catalytic beds according to example 1. As can be seen in FIG. 5, the catalytic beds according to examples 4 to 6, which were produced by treating the catalytic bed according to example 2 with sulfuric acid, showed improved conversion efficiency of nitrogen oxides as compared to that of the catalytic bed according to example 2. The improved efficiency may be due to an increased dispersion rate of silver in alumina carrier.

### EXAMPLE 17

The procedure of example 7 was repeated except that the catalytic bed according to example 2 was used instead of the catalytic bed according to example 1. An internal combustion power plant using 90% LNG+10% gasoline as a fuel was used instead of the LPG burner in example 7. The molar ratio of ethanol to nitrogen oxides was 2. The reactor temperature ranged from 200 to 550° C. At this time, the flow rate of the exhaust gas was controlled in such a way that the space velocity was 20,000 h⁻¹ at a hybrid mode (90% LNG+10% gasoline) in which the composition and concentration of the exhaust gas were stable after the internal combustion power plant was operated.

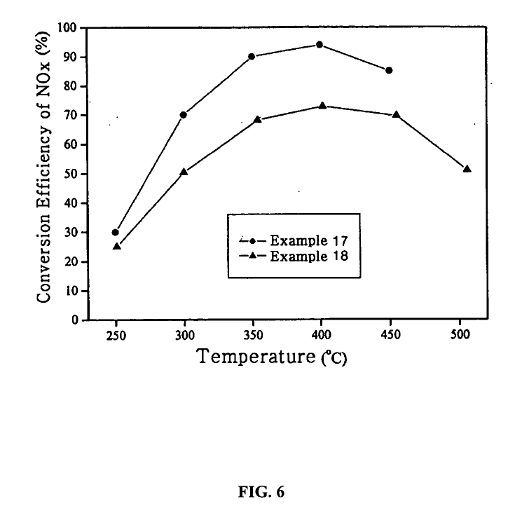

The composition of the exhaust gas fed into the reactor is described in Table 3. The calculated conversion efficiency of nitrogen oxide for this system is shown in FIG. 6.

### EXAMPLE 18

The procedure of example 7 was repeated except that the catalytic bed according to example 4 was used instead of the catalytic bed according to example 1. In an early stage, 100% gasoline was used as a fuel, and in a stable stage, an internal combustion power plant using 90% LNG+10% gasoline was used instead of the LPG burner in example 7. The molar ratio of ethanol to nitrogen oxides was 2. The temperature in the reactor temperature ranged from 200 to 550° C. The flow rate of the exhaust gas was controlled in such a way that the space velocity was 20,000 h⁻¹ at a hybrid mode (90% LNG+10% gasoline) in which the composition and concentration of the exhaust gas were stable after the internal combustion power plant was operated.

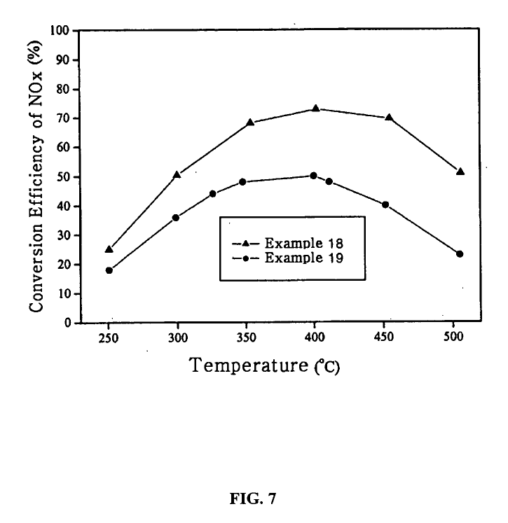

The composition of the exhaust gas fed into the reactor is described in Table 3. The calculated conversion efficiency of nitrogen oxide for this system is shown in FIGS. 6 and 7.

As can be seen in FIG. 6, the catalytic bed according to example 17 had higher conversion efficiency of nitrogen oxides than the catalytic bed according to example 18 at 250 to 450° C. This result indicates that the sulfuric acid-treated catalytic bed (example 4) has higher conversion efficiency of nitrogen oxides than the catalytic bed according to example 2 at a temperature 250 to 450° C.

### EXAMPLE 19

The procedure of example 7 was repeated except that the catalytic bed according to example 2 was used instead of the catalytic bed according to example 1. The exhaust gas discharged from an internal combustion power plant using 90% LNG+10% gasoline as a fuel instead of the LPG burner was used as a subjecting gas. The molar ratio of ethanol to nitrogen oxides was 1. The temperature in the reactor ranged from 200 to 550° C. The flow rate of the exhaust gas was controlled in such a way that the space velocity was 20,000 h⁻¹ at a hybrid mode (90% LNG+10% gasoline) in which the composition and concentration of the exhaust gas were stable after the internal combustion power plant was operated.

The composition of the exhaust gas fed into the reactor is described in Table 3. The calculated conversion efficiency of nitrogen oxide for this system is shown in FIG. 7.

As can be seen in FIG. 7, the catalytic bed according to example 18 had higher conversion efficiency of nitrogen oxides than the catalytic bed according to example 19 at 250 to 500° C. This result indicates that the conversion efficiency of nitrogen oxides increases as the molar ratio of ethanol to nitrogen oxides increases.

### EXAMPLE 20

As shown in FIG. 1, a rectangular reactor made of SUS 304 with a height of 15 cm, a width of 15 cm, and a length of 100 cm was provided, and a tube with a plurality of nozzles was installed in the front part of the reactor.

The catalytic bed produced according to example 2 was installed at the rear of the tube including a plurality of nozzles, and then another set of catalytic bed and tube as above was installed in the rear part of the reactor.

Ethanol, acting as the reducing agent, was injected into a storage tank that was connected to an injection pump. The injection pump was connected to the tube with the nozzles.

An air pump was then connected to the tube with the nozzles and fed high pressure air into the reactor.

Exhaust gas discharged from an internal combustion power plant using 90% LNG+10% gasoline as the fuel and a separate nitrogen monoxide were fed into the front part of the reactor. The flow rates of the exhaust gas and nitrogen monoxide were controlled using a mass flow controller.

Compositions and concentrations of gases fed into the reactor were described in Table 3. Reaction conditions were controlled in such a way that the temperature in the reactor ranged from 200 to 500° C., and the space velocity was 20,000 h⁻¹.

At this time, the molar ratio of ethanol sprayed into the exhaust gas through each of the tubes, including a plurality of nozzles, to nitrogen oxides was 0.5. The procedure of analyzing the resulting product was conducted as the same procedure as example 7.

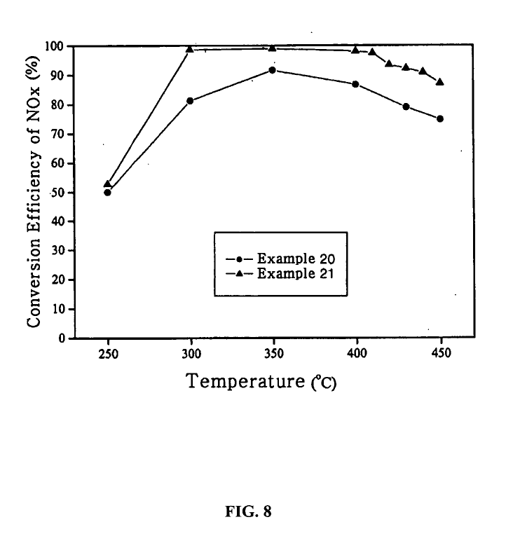

The results are shown in FIG. 8.

### EXAMPLE 21

The procedure of example 20 was repeated except that the molar ratio of ethanol to nitrogen oxides for each tube was 1 instead of 0.5. The procedure of analyzing the resulting product was conducted as the same procedure as example 7. The results are shown in FIG. 8.

### EXAMPLE 22

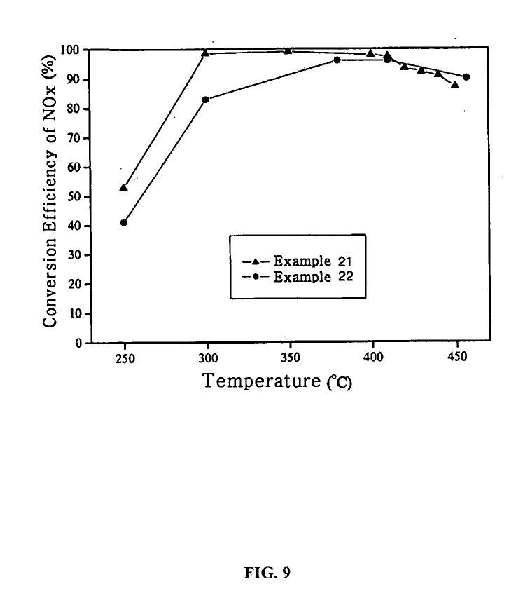

The procedure of example 20 was repeated except that 100% gasoline was used as a fuel of an internal combustion power plant instead of using a mixture of 90% LNG+10% gasoline. A flow rate and composition of exhaust gas fed into a reactor are described in Table 4. The procedure of analyzing the resulting product was conducted as the same procedure as example 7. The results are shown in FIG. 9.

TABLE 4
Flow rate and composition of the exhaust gas

| | Composition | | | | |
|---|---|---|---|---|---|
| Flow rate | NOx | CO | H₂O | O₂ | SO₂ |
| 90 Nm³h⁻¹ | 1500 ppm | 1000 ppm | 6% | 15% | 50 ppm |

From FIG. 9, it could be seen that the catalytic beds according to examples 21 and 22 both have excellent conversion efficiency of nitrogen oxides at temperatures ranging from 300 to 450° C.

### EXAMPLE 23

As shown in FIG. 1, a rectangular reactor [Gibo Co., Korea] made of SUS 304 with a height of 15 cm, a width of 15 cm, and a length of 100 cm was provided, and a tube with a plurality of nozzles [TN050-SRW, Total nozzle Co., Korea] was installed in the reactor.

The catalytic bed was installed according to example 1 behind the tube having a plurality of nozzles in the reactor.

Ethanol [Duk-san Pharmaceutical Industry Co. Ltd., Korea] acting as a reducing agent was charged into a storage tank. The storage tank was connected to an injection pump [M930, Younglin Co., Korea] that was connected to the tube with the nozzles.

An air pump [HP 2.5, Air bank compressor Co., Korea] was then connected to the tube with the nozzles to feed compressed air into the reactor.

The exhaust gas discharged from a LPG (liquefied petroleum gas) burner [Eg02.9R, Elco, Germany] of a boiler [Jewoo royal steam boiler, Jewoo energy, Korea] and nitrogen monoxide [Metson, USA] were fed into the reactor. The flow rates of the exhaust gas and nitrogen monoxide were controlled by using a mass flow controller [F-201C-FAC-22-V, Bronchost, Netherlands].

The flow rate and a composition of the exhaust gas are described in Table 5, below.

TABLE 5
Flow rate and composition of the exhaust gas

Composition

| Flow rate | N₂O | CO | H₂O | O₂ |
|---|---|---|---|---|
| 90 Nm³h⁻¹ | 700 ppm | 1400 ppm | 6% | 11% |

When the exhaust gas that was fed into the reactor passed through the inlet pipe, high pressure air and ethanol were simultaneously fed into the nozzles using both the air pump and injection pump so as to be sprayed into the exhaust gas passing through the reactor.

The molar ratio of ethanol to nitrogen oxides fed into the reactor was controlled to be 2. Reaction conditions were controlled in such a way that the temperature in the reactor was 200 to 550° C., and the space velocity was 20,000 h⁻¹.

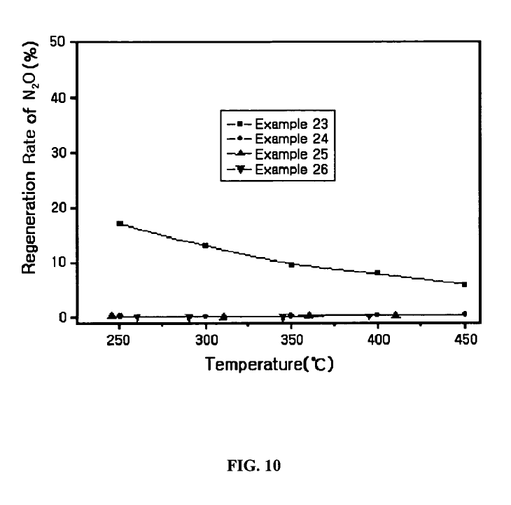

The generation rate of N₂O was calculated according to Equation 3. The calculated results are shown in FIG. 10.

$${N}_{2} O convers . ( \% ) = [ \frac{\begin{matrix}{N}_{2} O conc . before reaction - \\ {N}_{2} O conc . after reaction\end{matrix}}{{N}_{2} O conc . before reaction} ] \times 100 ( \% ) \qquad Equation 3$$

### EXAMPLE 24

The procedure of example 23 was repeated except that the catalytic bed according to example 4 was used instead of using the catalytic bed according to example 1. The generation rate of N₂O was calculated according to Equation 3. The calculated results are shown in FIG. 10.

### EXAMPLE 25

The procedure of example 23 was repeated except that the catalytic bed according to example 5 was used instead of using the catalytic bed according to example 1. The generation rate of N₂O was calculated according to Equation 3. The calculated results are shown in FIG. 10.

### EXAMPLE 26

The procedure of example 23 was repeated except that the catalytic bed according to example 6 was used instead of using the catalytic bed according to example 1. The generation rate of N₂O was calculated according to Equation 3. The calculated results are shown in FIG. 10.

As can be seen in FIG. 10, the sulfuric acid-treated catalytic beds according to examples 24 and 26 showed lower generation rates of N₂O than the catalytic bed according to example 23 at a temperature ranging from 200 to 500° C.

### Industrial Applicability

As described above, the present invention is advantageous in that the procedure of producing a catalytic bed can be varied, depending on the conditions of the exhaust gas from a stationary and a mobile source using gases or liquid oils as a fuel, such as gasoline, kerosene or bio-diesel oil. The present invention can effectively reduce nitrogen oxides to nitrogen and water by spraying a reducing agent into the exhaust gas according to a multi-injection manner in the presence of the catalytic bed.

The present invention is also advantageous in that the present invention utilizing ethanol as the reducing agent can improve the relatively low conversion efficiency of nitrogen oxides of a conventional HC-SCR process.

While this invention has been particularly shown and described with references to preferred embodiments thereof, it will be understood by those skilled in the art that various changes in form and details may be made therein without departing from the scope of the invention encompassed by the appended claims.

1. A catalyst for reducing nitrogen oxides comprising silver and an alumina carrier, wherein the alumina carrier supports silver.

2. The catalyst of claim 1, wherein the catalyst is further treated with sulfuric acid.

3. The catalyst of claim 2, wherein the treatment of the catalyst with sulfuric acid is performed by placing the catalyst in a 0.01 to 1 M sulfuric acid aqueous solution prior to drying and calcining the catalyst; or by allowing the catalyst to continuously come into contact with the flow of sulfur dioxide.

4. The catalyst of claim 1, wherein the nitrogen oxides are selected from the group consisting of NO, NO₂, N₂O₅, N₂O and a mixture thereof.

5. The catalyst of claim 1, wherein the content of alumina carrier in the catalyst is 0.05 to 0.3 g/cm³.

6. The catalyst of claim 1, wherein the catalyst has 0.1 to 10 wt % of silver based on the alumina carrier.

7. The catalyst of claim 1, wherein the alumina carrier has a crystalline structure selected from the group consisting of an amorphous structure, a gamma-type structure, a theta-type structure, an eta-type structure and a mixture thereof.

8. The catalyst of claim 1, wherein the silver is provided in a form of reduced silver, silver oxide, silver chloride, silver nitrate, silver sulfate, or a mixture thereof.

9. The catalyst of claim 1, wherein the catalyst is supported by a structure selected from the group consisting of a metal plate, a back filter, a ceramic filter, a ceramic honeycomb, and a ceramic cordierite honeycomb.

10. The catalyst of claim 1, wherein the catalyst is formed as a shape selected from the group consisting of a sphere, a pellet and a honeycomb.

11. An apparatus for treating nitrogen oxides, comprising:
an inlet pipe to receive exhaust gas;
a reactor connected to the inlet pipe, including:
one or more nozzles that are connected to the inlet pipe to spray air and a reducing agent into the exhaust gas received into the reactor through the inlet pipe; and
one or more catalytic beds installed behind the nozzle to reduce nitrogen oxides from the exhaust gas laden with the reducing agent;
a storage tank to store therein the reducing agent to be sprayed by the nozzle;
an injection pump installed between the storage tank and the nozzle to transport the reducing agent from the storage tank to the nozzle;
an air pump connected to the nozzle to feed air into the nozzle; and
an outlet pipe that discharges the exhaust gas after the exhaust gas passes through and is treated by the catalytic bed.

12. The apparatus of claim 11, wherein the catalytic bed for reducing nitrogen oxides comprises a catalyst that includes silver and an alumina carrier, wherein the alumina carrier supports silver.

13. The apparatus of claim 12, wherein the catalyst is further treated with sulfuric acid.

14. The apparatus of claim 13, wherein the treatment of the catalyst with sulfuric acid is performed by placing the catalyst in a 0.01 to 1 M sulfuric acid aqueous solution prior to drying and calcining the catalyst; or by allowing the catalyst to continuously come into contact with the flow of sulfur dioxide.

15. The catalyst of claim 12, wherein the nitrogen oxides are selected from the group consisting of NO, NO₂, N₂O₅, N₂O and a mixture thereof.

16. The apparatus of claim 12, wherein the content of alumina carrier in the catalyst is 0.05 to 0.3 g/cm³.

17. The apparatus of Clam 12, wherein the catalyst has 0.1 to 10 wt % of silver based on the alumina carrier.

18. The apparatus of claim 12, wherein the alumina carrier has a crystalline structure selected from the group consisting of an amorphous structure, a gamma-type structure, a theta-type structure, an eta-type structure and a mixture thereof.

19. The apparatus of claim 12, wherein the silver is provided in a form of reduced silver, silver oxide, silver chloride, silver nitrate, silver sulfate, or a mixture thereof.

20. The apparatus of claim 12, wherein the catalyst is supported by a structure selected from the group consisting of a metal plate, a back filter, a ceramic filter, a ceramic honeycomb, and a ceramic cordierite honeycomb.

21. The apparatus of claim 11, further comprising one or more tubes, each including one or more nozzles that are installed in the reactor in a single- or multi-injection manner, wherein the catalytic bed is installed behind each of the tubes so that air and the reducing agent are sprayed into the exhaust gas through the tubes.

22. The apparatus of claim 11, further comprising:
a valve installed at each of the tube to control the flow rate of a fluid passing through the tube;
one or more concentration sensors installed in the inlet pipe, the reactor and the outlet pipe to sense a concentration of nitrogen oxides contained in the exhaust gas flowing in the inlet pipe, the reactor, and the outlet pipe; and
a control unit connected to the concentration sensor and valve to control the valve based on concentration data output from the concentration sensor.

23. The apparatus of claim 11, wherein the reducing agent is selected from the group consisting of unsaturated hydrocarbon, heterogeneous hydrocarbon and a mixture thereof.

24. A method of treating nitrogen oxides using the apparatus of claim 11, comprising the steps of:
receiving the exhaust gas through the inlet pipe;
spraying air and the reducing agent into the exhaust gas by the nozzles;
reducing nitrogen oxides from the exhaust gas laden with the reducing agent on the catalytic bed;
discharging the exhaust gas after the exhaust gas passes through and is treated by the catalytic bed.

25. The method of claim 24, wherein the catalyst for reducing nitrogen oxides comprises silver and an alumina carrier that supports silver.

26. The method of claim 25, wherein the catalyst is further treated with sulfuric acid.

27. The method of claim 26, wherein the treatment of the catalyst with sulfuric acid is performed by placing the catalyst in a 0.01 to 1 M sulfuric acid aqueous solution prior to drying and calcining the catalyst; or by allowing the catalyst to continuously come into contact with the flow of sulfur dioxide.

28. The catalyst of claim 25, wherein the nitrogen oxides are selected from the group consisting of NO, NO₂, N₂O₅, N₂O and a mixture thereof.

29. The method of claim 25, wherein the content of alumina carrier in the catalyst is 0.05 to 0.3 g/cm³.

30. The method of claim 25, wherein the catalytic bed has 0.1 to 10 wt % of silver based on the alumina carrier.

31. The method of claim 25, wherein the alumina carrier has a crystalline structure selected from the group consisting of an amorphous structure, a gamma-type structure, a theta-type structure, an eta-type structure and a mixture thereof.

32. The method of claim 25, wherein the silver in the catalyst is provided in a form of reduced silver, silver oxide, silver chloride, silver nitrate, silver sulfate, or a mixture thereof.

33. The method of claim 25, wherein the catalyst is supported by a structure selected from the group consisting of a metal plate, a back filter, a ceramic filter, a ceramic honeycomb, and a ceramic cordierite honeycomb.

34. The method of claim 24, wherein the apparatus further comprises one or more tubes, each including one or more nozzles, are installed in the reactor in a single- or multi-injection manner, and the catalytic bed is installed behind each of the tubes so that air and the reducing agent are sprayed into the exhaust gas through the tubes.

35. The method of claim 24, wherein the apparatus further comprising:
a valve installed at each of the tube to control the flow rate of a fluid passing through the tube;
one or more concentration sensors installed in the inlet pipe, the reactor and the outlet pipe to sense a concentration of nitrogen oxides contained in the exhaust gas flowing in the inlet pipe, the reactor, and the outlet pipe; and
a control unit connected to the concentration sensor and valve to control the valve based on concentration data output from the concentration sensor.

36. The method of claim 24, wherein the reducing agent is selected from the group consisting of unsaturated hydrocarbon, heterogeneous hydrocarbon and a mixture thereof.
